(19) United States
(12) Patent Application Publication
(10) Pub. No.: US 2018/0054806 A1
(43) Pub. Date: Feb. 22, 2018

(54) SYSTEMS AND METHODS FOR DECOUPLING CONTROL AND DATA CHANNELS IN WIRELESS NETWORKS

(71) Applicant: Alcatel-Lucent USA, Inc., Murray Hill, NJ (US)

(72) Inventors: Krishna Balachandran, Morganville, NJ (US); Joseph H. Kang, Belle Mead, NJ (US); Kemal M. Karakayali, Hoboken, NJ (US); Kiran M. Rege, Marlboro, NJ (US)

(73) Assignee: Alcatel-Lucent USA, Inc., Murray Hill, NJ (US)

(21) Appl. No.: 15/242,600

(22) Filed: Aug. 22, 2016

(51) Int. Cl. H04W 72/04; H04W 72/08; H04L 5/00

(52) U.S. Cl. CPC H04W 72/042; H04L 5/0032; H04W 72/082; H04W 72/085

(57) ABSTRACT

The downlink control and uplink data channels between wireless user equipment and a wireless cell site are decoupled, allowing the user equipment to send data payloads to a second cell site via a different uplink data channel that provides greater throughput and/or a higher quality-of-experience for a user of the user equipment.

### INTRODUCTION

In a typical wireless communication network, physical channels can be broadly grouped into two categories: control channels and data channels. Control channels provide signals that include basic information necessary to establish communications between transmitters and receivers (e.g. time/frequency resources in which data transmission will occur, modulation/coding format selections, hybrid automatic repeat request feedback information etc.) while data channels mainly carry data payloads (sometimes referred to as simply “data”).

In today's wireless networks, a cellular network site (i.e., a “cell”) consists of a base station for transmitting control signals (e.g. scheduling grants) to user equipment (UE) over a downlink control channel. A cell that transmits control signals to a specific UE is referred to as the UE's “serving cell”. The control signals received by the UE enable the UE to, thereafter, transmit data payloads over an uplink data channel that is established between the UE and the same serving cell. The use of the same cell to provide both a downlink control channel and an uplink data channel to a UE is referred to as “association coupling.”

Typically, there is a fixed time lag between the transmission of control signals over a downlink control channel carrying a scheduling grant (indicating the resources and modulation/coding formats to be used) and the corresponding transmission of data payloads over an uplink data channel. This is referred to as “timing coupling.” Association and timing couplings create inefficiencies that limit the quality-of experience (QoE) for a significant number of users of UEs, especially those that must rely on transmitting data payloads via the uplink of a cell in a heterogonous wireless network (HetNet).

In more detail, typically in a HetNet the UEs become associated with a serving cell based on the strength of the downlink signal that is received by the UE. Said another way, a UE typically selects the strongest downlink control signal among a number of such signals to become associated with. In accordance with existing cellular network methodologies, once the UE selects a downlink control signal and its corresponding channel from a particular cell to become associated with, that cell becomes the UE's serving cell and the UE is also required to use the uplink channels that are associated with the same cell as data channels. This is true even though higher quality uplink data channels may be available to the UE from other cells. In one typical example, a UE will be forced to use the uplink data channel of a remote (relatively speaking) high-power, macro-cell even though a higher quality uplink data channel is available from a nearby (relatively speaking) low-power, small cell. Thus, a UE is forced to use a lower quality, uplink data channel.

FIG. 1A illustrates an example of association coupling that occurs within existing wireless networks. FIG. 1A depicts an exemplary co-channel HetNet 1 that includes a UE 3, and a low-power small-cell 4 deployed within the downlink coverage area 6 (also referred to, simply, as coverage area) of a high-power macro-cell 2. According to existing methodologies, UE 3 will become associated with the macro-cell 2 via downlink control channel 8 and uplink data channel 9 because the macro-cell's 2 downlink control channel 8 has a higher downlink transmit power (e.g., by 16 dB) than the transmit power of the downlink control channel of small-cell 4. This association will occur despite the fact that the quality of the uplink data channel 9 may be less than the quality of an uplink data channel between the UE 3 and small-cell 4 (not numbered in FIG. 1A). That is to say, using existing methodologies, even though UE 3 would provide a better QoE to its user if it were allowed to utilize the higher quality uplink data channel between it and small-cell 4, the UE 3 is required to use the lower quality uplink data channel 9 between it and the macro-cell 2.

One attempted solution expands the coverage area of small cell 4. For example, in 3GPP-LTE Release 10, enhanced Inter-cell Interference Coordination (eICIC) techniques are introduced to expand the coverage area of small-cell 4. Referring now to FIG. 1B, an expanded area 7 for the small-cell 4 is shown. To realize the expanded area, certain sub-frames from macro-cell 2 are muted or “blanked (i.e., almost devoid of control signals). During the time period that the frames are muted, UE 3 may reliably receive control signals from, and transmit data payloads to, small-cell 4 using respective downlink and uplink channels 10,11 without interference from the macro-cell 2.

In one example of such a blanking technique, 35% of the sub-frames from the macro-cell 2 may be blanked.

However, this solution is not without its own problems. For example, this solution leads to severe uplink resource under-utilization (resource starvation) at a macro-cell (i.e., an inefficient macro-cell) due to the elimination of a large number of potential data transmission opportunities because of blanked sub-frames.

Other alternative solutions have been attempted or suggested, but they each have significant drawbacks such as the requirement of an expensive high-speed backhaul (e.g., high speed fiber optic cable and equipment) between cells (e.g. between macro and small cells).

Accordingly, it is desirable to provide systems and methods that decouple control and data channels while providing a user with a high QoE without sacrificing the efficiency of a macro-cell or requiring the use of a high-speed backhaul.

### SUMMARY

We have recognized that problems with existing methodologies can be overcome by providing systems and methods for decoupling the control and data channel of a UE. In an embodiment, one such system may comprise a hardware controller that may be operable to (1) receive measurements of one or more parameters associated with a plurality of uplink data channels, a first number of the channels provided by a serving wireless cell operable to provide a downlink control channel to user equipment and a second number of the channels provided by one or more non-serving wireless cells for the wireless user equipment, and (2) select the uplink data channel, from among the plurality of uplink data channels, that comprises the highest quality or that provides the highest throughput based on the received measurements and which is provided by one of the one or more non-serving wireless cells. This system effectively decouples the control and data channels of a UE.

The exemplary controller may be further operable to generate signals for transmission to user equipment, for example, the signals instructing the UE to use the selected uplink data channel to send data payloads to the non-serving wireless cell that is providing the selected uplink data channel.

In exemplary embodiments, the controller may be part of the serving wireless cell, another cell, or a part of a network management system (NMS). Yet further, the controller may be a part of a base station, where the base station may be operable to exchange control signals with the UE via the downlink control channel.

In another embodiment, the system may include UE that is (are) operable to receive control signals from the serving wireless cell (e.g., a macro-cell), and transmit data payloads to one of the non-serving wireless cells (e.g., a small-cell).

In yet another embodiment, the serving wireless cell may be operable to transmit downlink control signals at a power level that is higher than downlink control signals transmitted by the non-serving wireless cells.

In still additional embodiments, the non-serving wireless cell that is providing the selected uplink data channel may be operable to complete: (i) baseband processing, (ii) baseband processing and co-ordinated scheduling with the serving wireless cell for the reception of data payloads from a plurality of user devices, including the user equipment, to mitigate interference, (iii) reception and decoding of data payloads from other user equipment that has previously been associated with the non-serving wireless cell, cancel the signal contribution from the other equipment and attempt to decode the data payloads from the user equipment to mitigate interference, and (iv) baseband processing, co-ordinated scheduling with the serving wireless cell of the reception of data payloads from a plurality of user equipment, and power control.

In addition to the exemplary systems described above (and herein) the present invention also provides for various methods for decoupling wireless control and data channels of a UE. On such method comprises (a) receiving measurements, at a hardware controller, of one or more parameters associated with a plurality of uplink data channels, a first number of the channels provided by a serving wireless cell operable to provide a downlink control channel to user equipment and a second number of the channels provided by one or more non-serving wireless cells for the wireless user equipment, and (b) selecting the uplink data channel, from among the plurality of uplink data channels, by the hardware controller that comprises the highest quality or that provides the highest throughput based on the received measurements and which is provided by one of the one or more non-serving wireless cells.

Such an exemplary method may further comprise generating signals for transmission to a UE, for example, the signals for instructing the UE to use the selected uplink data channel to send data payloads to the non-serving wireless cell that is providing the selected uplink data channel, and exchanging control signals with the UE via the downlink control channel.

The exemplary method may further include receiving control signals at UE from the serving wireless cell, and transmitting data payload to one of the non-serving wireless cells from the UE.

In addition to completing the inventive methods described briefly above, additional exemplary methods of the present invention may include: (i) completing baseband processing at the non-serving wireless cell that is providing a selected uplink data channel, (ii) completing baseband processing and coordinating scheduling at the non-serving wireless cell, that is providing the selected uplink data channel, with the serving wireless cell for the reception of data payloads from a plurality of user devices, including UE, to mitigate interference, (iii) receiving and decoding data payloads from other UE that has previously been associated with the non-serving wireless cell, cancelling the signal contribution from the other equipment and attempting to decode the data payloads from the UE to mitigate interference by the non-serving wireless cell that is providing the selected uplink data channel, and (iv) completing baseband processing, coordinating scheduling with the serving wireless cell of the reception of data payloads from a plurality of UE, and performing power control by the non-serving wireless cell that is providing the selected uplink data channel.

Additional systems and methods will be apparent from the following detailed description and appended drawings.

### BRIEF DESCRIPTION OF THE DRAWINGS

FIGS. 1A and 1B depict an existing wireless network.

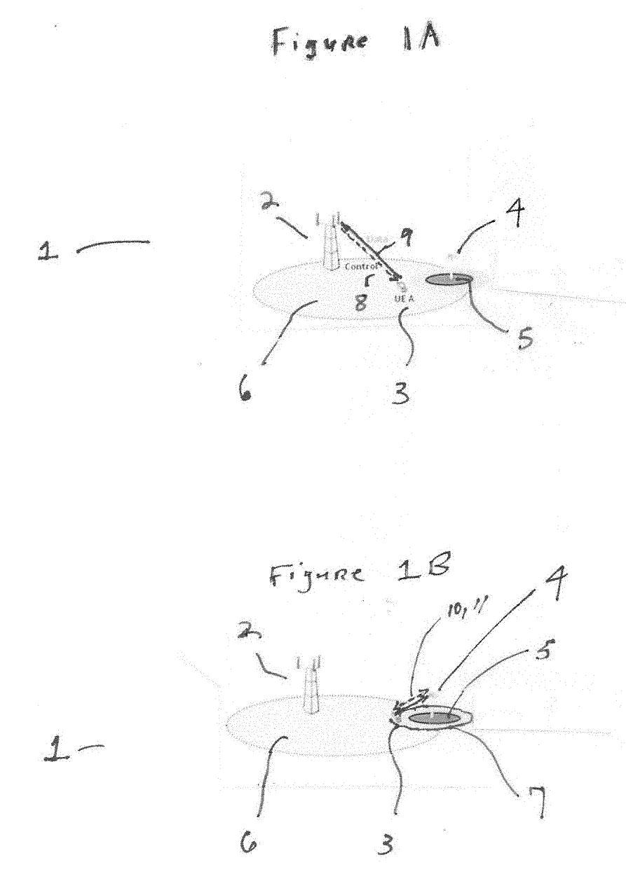

FIG. 2A depicts a wireless network that utilizes inventive decoupling systems and methods described herein according to embodiments of the invention.

FIG. 2B depicts an exemplary base station of a macro-cell according to an embodiment of the invention.

FIG. 2C depicts an exemplary base station of a small-cell according to an embodiment of the invention.

FIG. 2D depicts exemplary user equipment according to an embodiment of the invention.

FIG. 3A depicts an exemplary flowchart of one or more methods according to one or more embodiments of the invention.

FIG. 3B depicts an exemplary flowchart of additional methods according to one or more additional embodiments of the invention.

### DETAILED DESCRIPTION

Exemplary embodiments of systems and methods for decoupling downlink control and uplink data channels in wireless networks are described herein and are shown by way of example in the drawings. Throughout the following description and drawings, like reference numbers/characters refer to like elements.

It should be understood that, although specific exemplary embodiments are discussed herein, there is no intent to limit the scope of the present invention to such embodiments. To the contrary, it should be understood that the exemplary embodiments discussed herein are for illustrative purposes, and that modified and alternative embodiments may be implemented without departing from the scope of the present invention.

It should also be noted that one or more exemplary embodiments may be described as a process or method. Although a process/method may be described as sequential, it should be understood that such a process/method may be performed in parallel, concurrently or simultaneously. In addition, the order of each step within a process/method may be re-arranged. A process/method may be terminated when completed, and may also include additional, well-known steps not included in a description of the process/method.

As used herein, the term “and/or” includes any and all combinations of one or more of the associated listed items. As used herein, the singular forms “a,” “an” and “the” are intended to include the plural form, unless the context and/or common sense indicates otherwise.

It should be understood that when a component or element of an inventive system is referred to, or shown in a figure, as being “connected” to (or other tenses of connected) another component or element such components or elements can be directly connected, or may use intervening components or elements to aid a connection. In the latter case, if the intervening components and elements are well known to those in the art they may not be described herein.

When used herein the phrase “hardware controller” means an electronic device such as a microchip, expansion card, or a stand-alone device that interfaces with memory and uses stored electronic instructions to control and manage the operation of a larger device or system, such as a base station.

When the words “first” or “second” or other similar words denoting a number are used it should be understood that the use of these words does not denote a level of importance or priority. Rather, such words are used to merely distinguish one element or component from another. Relatedly, it should be understood that one or more of these elements or components may be combined to form fewer elements/components, or, may be further divided to form additional elements/components.

As used herein the term “macro-cell” means a system that transmits and receives radio frequency (RF) signals and data payloads at (relatively) high power levels. It should be understood that a macro-cell may comprise a fixed (by location) transceiver that is a part of a base station. Typically, the coverage area of a macro-cell is between 500 meters to several kilometers.

As used herein the phrase “small-cell” means a system that transmits and receives RF signals and data payload using low-power levels. Typically, a small cell has a coverage area of 10 meters to a few hundred meters.

As used herein the term “cell” means a macro-cell or a small cell.

Connected together, macro-cells and small-cells make up a wireless network.

Where used herein the phrase “ideal backhaul” means a high throughput and low latency communication medium. For example, a throughput of 10 Gbps and a latency of less than 2.5 microseconds. Accordingly, the phrase “non-ideal” backhaul means a communication medium that provides a lower throughput and higher latency than an ideal backhaul.

When used herein the phrase “user equipment” or UE includes all types of mobile devices, such as phones, laptop computers, desktop computers, tablets, phablets or any other device that can be used by a user that is moving from one location to another and that is equipped with the necessary electronics to send and receive signals and data payloads over a wireless RF network.

As used herein, the term “embodiment” refers to an example of the present invention.

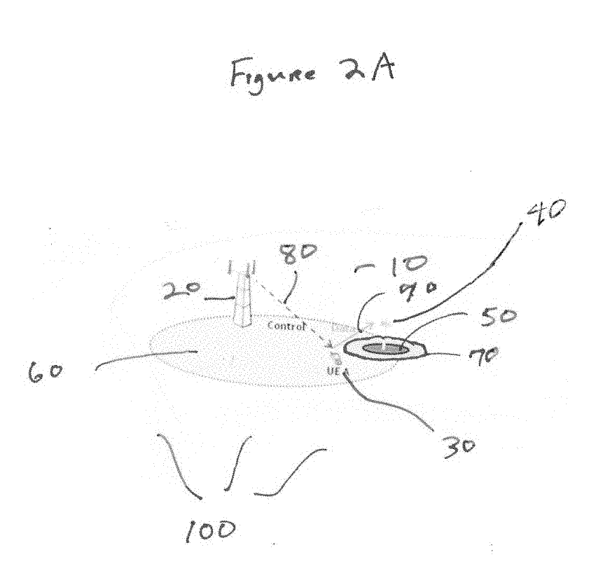

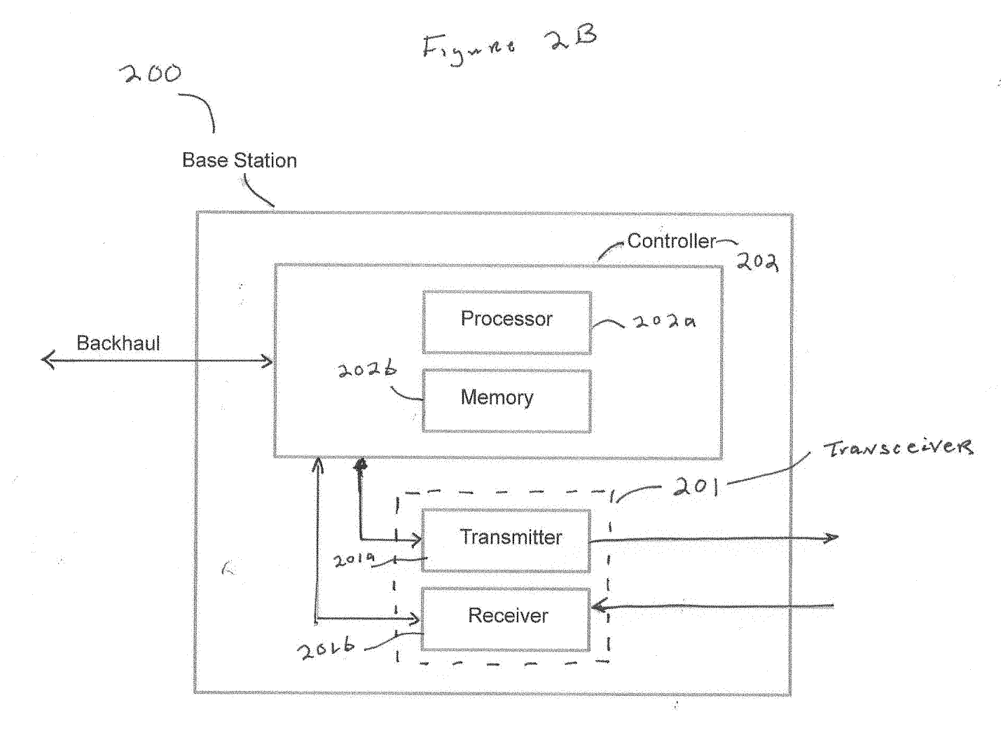

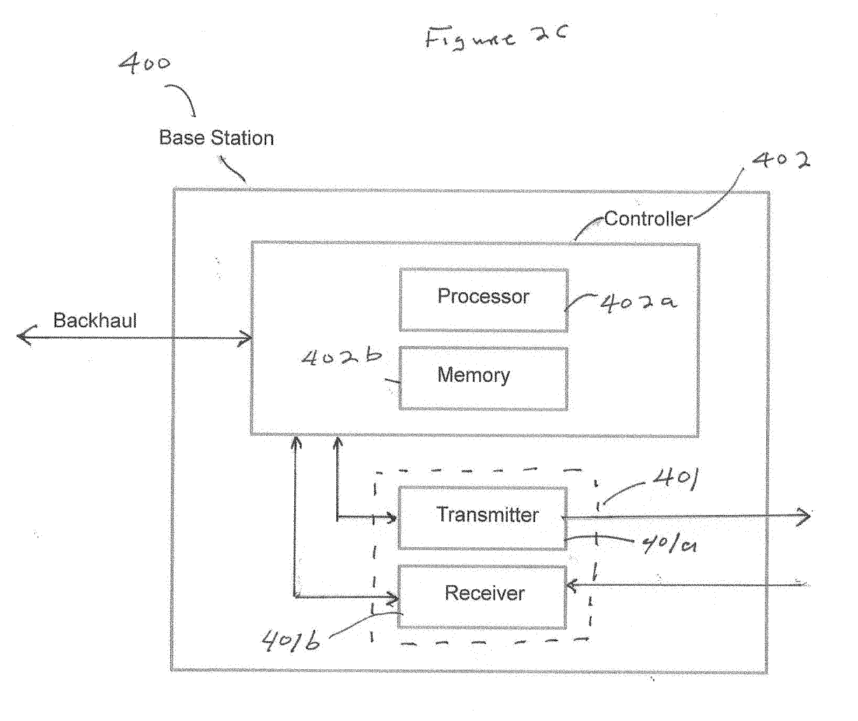

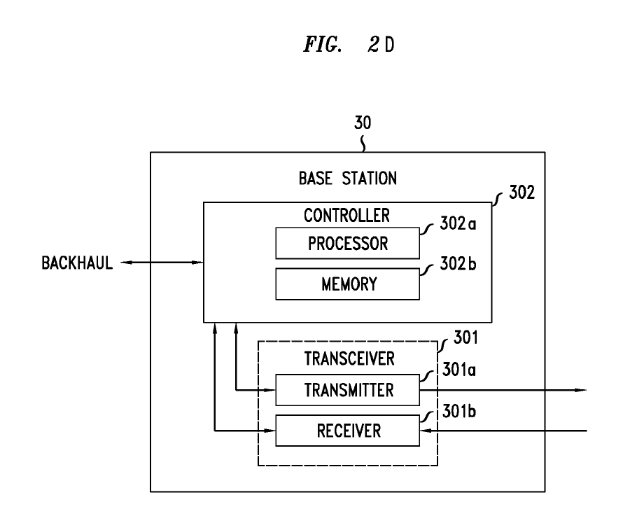

Referring now to FIG. 2A there is depicted a system 10 according to one embodiment where the downlink control and uplink data channels are decoupled, that is where downlink control signals are provided by a first cell (e.g., a macro-cell 20) via a downlink control channel 80 and data payloads are sent from the UE 30 to a second, different cell (e.g., small-cell 40) via an uplink data channel 90 within a wireless network 100. Network 100 may be any type of wireless network, though in the embodiment depicted in FIG. 2A network 100 is a 5G wireless network. Because cell 20 provides the downlink control signals, it may be referred to as the UE's 30 “serving cell” while cell 40 may be referred to as a “non-serving” cell. Though only one non-serving cell 40 is shown in FIG. 2A, it should be understood that the network 100 may include a plurality of non-serving cells.

Referring now to FIG. 2B, macro-cell 20 may comprise a base station 200. In one embodiment, base station 200 may include at least a transceiver 201 (e.g., combination of a transmitter 201a and receiver 201b) for exchanging control signals (and data payloads when necessary) with the UE 30 as well as a hardware controller 202 that may comprise one or more processors 202a, and associated memory 202b. The processor 202a may be operable to generate the control signals that are sent to the UE 30 based on executing instructions stored in memory 202b and process responsive signals received from the UE 30. When the macro-cell 20 is referred to herein as being “operable to” perform a specified feature, function or process, it should be understood that this means the components of its base station 200 are completing the feature, function or process.

In more detail, the hardware controller 202 may be operable to receive measurements of one or more parameters associated with a plurality of uplink data channels via transceiver 201, for example. The parameters relate to both the quality of each uplink data channel between UE 30 and a cell, and the load on cells. In one embodiment, the plurality of uplink data channels whose measurements are received by the controller 202 include those channels provided by at least the serving cell 20 that is providing the downlink control channel to UE 30 and one or more non-serving wireless cells, such as cell 40.

Upon receiving such measurements, the controller 202 may be operable to select the uplink data channel, from among a first number of channels provided by the serving cell 20 and from a second number of channels provided by the non-serving cell 40 (or cells), that comprises the highest quality or that provides the highest throughput based on the received measurements. In accordance with embodiments of the invention, the controller 202 will select an uplink data channel that is provided by one of the one or more non-serving wireless cells, such as cell 40, and not the serving cell 20 that is providing the downlink control signals. This ability to select an uplink data channel from a cell other than the cell that is provided the downlink control signals “decouples” the data payloads and control signals. This ability is believed to be distinctive by the inventors.

Yet further, upon selecting an uplink data channel, the controller 202 may be further operable to generate signals for eventual transmission to the UE 30 via transceiver 201, for example, the signals used to instruct the UE 30 (or another device or cell that instructs the UE) to use the selected uplink data channel in order to send data payloads to the non-serving wireless cell 40 that is providing the selected uplink data channel.

While the decision to select an uplink data channel may be determined by base station equipment that is part of macro-cell 20, such as controller 202, this need not necessarily be the case. In alternative embodiments, this decision may be made by a controller located at an NMS that is separate from a cell (e.g., controller 202).

Referring now to FIG. 2C, small-cell 40 may comprise a base station 400 that may comprise at least a transceiver 401 (e.g., transmitter 401a and receiver 401b) for sending control signals to UE 30 when necessary, and for receiving data payloads from UE 30 over an uplink data channel. The base station 400 may also comprise a controller 402 that comprises one or more processors 402a and associated memory 402b. The processor 402a may be operable to generate signals that are sent to the UE 30 and process responsive signals and received data payloads from the UE 30 based on executing instructions stored in memory 402b. When the small-cell 40 is referred to herein as being “operable to” perform a specified feature, function or process, it should be understood that this means the components if its base station 400 are completing the feature, function or process.

As illustrated in FIG. 2A, in one embodiment when the uplink data channel 90 between the small-cell 40 and UE 30 is selected as the highest quality data channel (e.g., either by received power or throughput measurements), small-cell 40 may be operable to receive data payloads from UE 30 via the channel 90.

Referring to FIG. 2D, UE 30 may include at least a transceiver 301 (transmitter 301a and receiver 301b) for exchanging control signals with a first cell (e.g., macro-cell 20, and/or small cell 40), and transmitting data payloads to second cell (e.g., small-cell 40 or macro-cell 20). The UE 30 may further include a controller 302 that may comprise one or more processors 302a and associated memory 302b. The processor 302a may be operable to generate the necessary signals for exchanging the control signals and transmitting the data payloads based on executing instructions stored in memory, for example. When the UE 30 is referred to herein as being “operable to” perform a specified feature, function or process, it should be understood that this means its transceiver 301, processor 302a and/or memory 302b, or some combination of the above components complete the feature, function and process.

In more detail, in an embodiment the UE 30 may be operable to measure the downlink signal strength of a signal (e.g. reference signal transmit power (RSRP) in Long Term Evolution (LTE)) transmitted from the macro-cell 20 as well from other cells not shown in FIG. 2A. Thereafter, the UE 30 may be operable to associate or “attach” itself to the cell whose measured signal strength is the highest, for example, (e.g., strongest RSRP+some bias value). In the embodiment of FIG. 2A, this is cell 20.

However, in contrast to existing techniques, rather than automatically using the uplink data channel of the associated macro-cell 20, in accordance with the present invention the UE 30 is associated with the uplink data channel of the cell that provides the highest quality uplink, for example. While in some cases this may result in the use of an uplink data channel provided by the same cell that provides the downlink control channel, in accordance with the present invention that is not necessarily the case. Rather, as illustrated in FIG. 2A, the UE 30 (on its uplink) will become associated with small-cell 40 (i.e., will become associated with the cell that is not providing the downlink channel).

As mentioned earlier, the decision as to which uplink data channel UE 30 should become associated with may be determined by the macro-cell 20, by another cell, or by another system, such as a network management system (NMS).

In more detail, the measurement of the strength, quality or other desirable parameter of a particular uplink data channel may be made by the cell that is providing the particular channel to the UE (e.g., by its controller, etc.,).

For example, in a Long-term Evolution (LTE) network, a UE may transmit a sounding reference signal to a cell, such as cell 40. Upon receiving this signal, the cell 40 may be operable to measure the strength or quality of the uplink data channel that is provided to the UE 30. Alternatively, a cell may be further operable to measure its load in order to determine whether a UE should select an uplink data channel being provided by the cell. The cell may receive similar measurements made by other cells, and then compare its measurement to the other received measurements in order to determine whether its uplink data channel or that of another cell should be used by an UE to transmit data payload(s).

Yet further, the measurements may be made by each cell and then sent to a centralized controller that is part of an NMS, for example. The controller (e.g., controller 202) at the NMS may be operable to receive the measurements discussed previously with respect to controller 202, compare the measurements made by each cell, select which uplink data channel has the highest quality or highest throughput for a particular UE, and then send messages to the cells (and/or the UE) that sent the measurement information (instructing them as to which uplink data channel (and which cell) a particular UE should use. Again, while in some cases this may result in the use of an uplink data channel by the UE that is provided by the same cell that is providing the UE its downlink control channel, in accordance with the present invention that is not necessarily the case. Rather, as described herein, the UE (on its uplink) will become associated with the cell that is selected by the NMS (i.e., the cell that is not providing the downlink channel).

As explained previously, the serving cell of a UE is operable to transmit downlink control signals at a power level such that those signals are typically received at a higher signal-to-interference+noise ratio (SINR) than if they were transmitted by non-serving cells. Once the serving cell of a UE has been determined, an uplink data channel associated with that cell (e.g., macro-cell 20) may be selected if it is determined that the signal strength of its downlink control channel is more than 6 or 9 dB higher than the signal strength of a second cell (small-cell 40). Alternatively, as indicated before the decision to select an uplink associated with one cell over that associated with another may be based on the load being carried by those cells. For instance, if a first cell is serving several tens of users while a second cell is serving just three or four, a UE may receive a significantly better throughput if it uses the uplink provided by the latter even if the corresponding SINR is somewhat lower. Accordingly, it should be understood that the decoupling of control channels from data channels may occur even where a UE (e.g., UE 30) experiences uplink reception conditions between the UE and non-serving cell (e.g., small-cell 40) that are comparable (or even worse) than those it is experiencing between itself and a serving cell (e.g., macro-cell 20). Said another way, the present systems and methods are not limited to those instances where the uplink conditions (i.e., SINR) between the UE and a non-serving, small-cell are better than the uplink between the UE and a serving macro-cell. The reason for this is that it may be beneficial for the UE if the non-serving cell allocates resources for the UE when the non-serving cell is lightly loaded. In other words, when there is more bandwidth available at the non-serving cell (e.g., more data payloads can be sent over an uplink between the UE and a non-serving cell). The availability of bandwidth may overcome the potentially worse SINR conditions that exist, and lead to a higher throughput. In such a scenario, control signals would be delivered by the high-power serving cell to the UE via its downlink control channel, but the allocation of resources for uplink data transmission and the processing of the received uplink data received via an uplink data channel will be done by the non-serving cell.

In the embodiment depicted in FIG. 2A, the small-cell 40 may be operable to receive and decode data payloads received via uplink data channel 90 from the UE 30. In addition, it should be understood that the small cell 40 may also be operable to complete some or all of the resource allocation decisions (e.g., number of physical resource blocks (PRBs) allocated to the UE 30, modulation/coding format selection). However, the control signals indicating these decisions may be delivered to the UE 30 by the macro-cell 20. In an embodiment, this requires that the small-cell 40 be operable to provide signals (e.g. downlink control information or “DCI”) to the macro-cell 20 in a timely manner for eventual delivery to the UE 30 via macro cell 20's physical downlink control channel (“PDCCH”) 80. The small cell 40 provides said downlink control information to macro cell 20 over the backhaul links connecting the small cell 40 to macro cell 20 (not shown in FIG. 2A). In an embodiment of the invention, the exchange of DCI signals between the small-cell 40 and the macro-cell 20 occurs without the need for a high-capacity backhaul (i.e., a “non-ideal” backhaul situation) between the two. This capability is also believed to be distinctive by the inventors.

In embodiments, decoupling the downlink control channel from the uplink data channel is believed to improve “link budgets” for UEs because it allows a UE to determine which cell and channel to communicate over that results in the highest quality or the highest throughput, and therefore, highest QoE for a user. This is especially relevant where a number of UEs are within the coverage area of a macro-cell but would be better served by communicating with a small-cell to transmit their data payloads via an uplink data channel to the small cell.

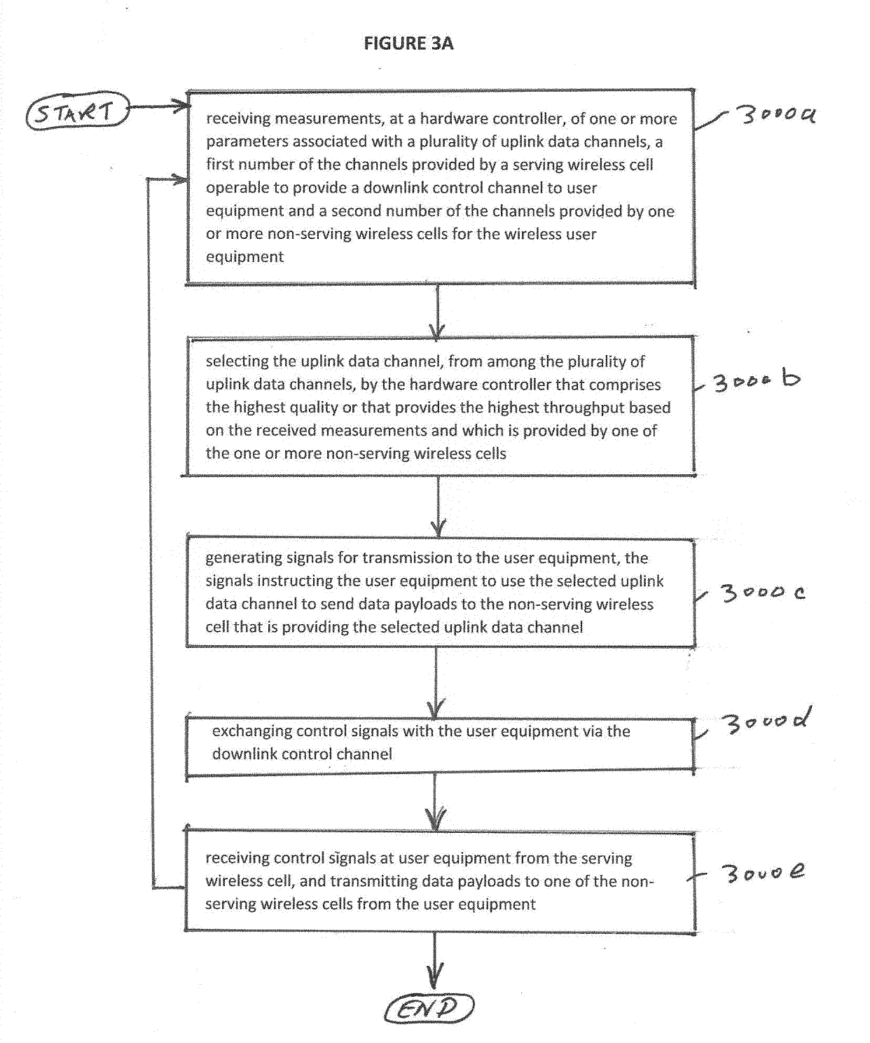

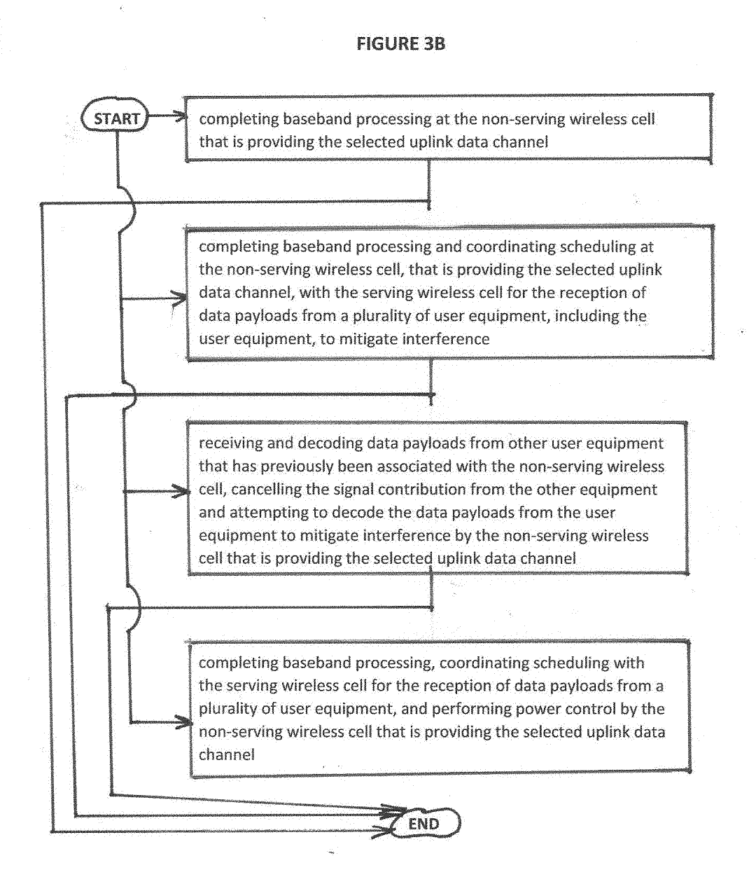

FIG. 3A depicts a simplified flowchart of a method that includes steps 3000a through 3000e for decoupling control and data channels and their associated signals and data payloads according to the description set forth above and elsewhere herein.

In existing wireless networks, where both control signals and data payloads are exchanged between a cell, say a macro-cell, and a UE, a number of functions need to be completed once the UE becomes associated with the macro-cell via both uplink and downlink channels. For example, the main functions are resource allocation (e.g., the number of PRBs allocated to a UE), power control, (informing the UE regarding resource allocation and power control decisions) and baseband processing (receiver processing and decoding). Accordingly, in systems provided by the present invention that use de-coupled control and data channels, such functions, as well as other functions, may be separately completed by either a UE's serving cell, say a macro-cell, that is providing control signals to the UE, and the non-serving cell of the UE, say a small-cell, that is receiving data payloads from the UE. In accordance with the invention, many possible embodiments are feasible, namely: (i) certain functions are completed by the serving cell that is providing the control signals, (ii) certain other functions are completed by the non-serving cell that is receiving data payloads from the UE, (iii) certain functions are completed by both cells, or (iv) some combination of options (i) through (iii). Some of the possible options are summarized in Table 1 below:

TABLE 1

| | | | Scheduling/ | |
|---|---|---|---|---|
| | Control | Baseband | Resource | Power |
| | Delivery by | Processing @ | Allocation @ | Control @ |
| Option 1 | Macro-cell | Small-cell | Macro-cell | Macro-cell |
| Option 2 | Macro-cell | Small-cell | Macro-cell, in | Macro-cell |
| | | | coordination with | |
| | | | Small-cell | |
| Option 3 | Macro-cell | Small-cell | Small-cell | Small-cell |

In Option 1, the UE 30 may be operable to transmit data payloads via an uplink data channel 90 between itself and small-cell 40 because, for example, such an uplink has lower path-loss than an uplink data channel between the UE 30 and macro-cell 20. However, in this option the small-cell 40 that is providing the uplink data channel will be further operable to complete baseband processing, while other functions are left to be completed by the macro-cell 20. The potential benefit of Option 1 is that it provides improved receiver processing by the small-cell 40 because of the “geometry, i.e. better SINR, between the small-cell 40 and UE 30.

Option 2 is similar to Option 1 where the non-serving small-cell 40 that is providing the uplink data channel 90 is responsible for completing baseband processing for UE 30 (e.g., an “edge” macro mobile device), and, in addition, is responsible for coordinating its own scheduling decisions with the macro-cell 20 (e.g. the small-cell 40 may not schedule another UE in the same PRBs that are allocated to UE 30). Therefore, it is believed that Option 2 provides interference avoidance benefits.

In an alternative embodiment that may provide similar interference avoidance/mitigation benefits, the non-serving small-cell 40 that is providing the uplink data channel 90 may be operable to first decode data payloads from another UE (e.g., one that has been associated with the small-cell 40, and not the macro-cell 20), eliminate the interference caused by the data payloads from the overall received signal that includes data payloads from UE 30, and attempt to decode the data payloads from UE 30 (e.g., a UE that has been associated with the macro-cell 20).

Option 3 represents a fully decoupled scenario where all, or substantially all, of the functions described above are completed by the small-cell 40 (e.g., baseband processing, coordinating its own scheduling decisions with the macro-cell 20, and power control, i.e. determining the power level at which UE 30 should transmit its data payloads), except, of course, for the delivery of control signals via a downlink control channel 80 from the macro-cell 20. Option 3 is believed to provide the greatest flexibility, and additional load balancing benefits because resource allocations are done by the small-cell 40.

FIG. 3B depicts a simplified flowchart that includes steps 3100a through 3100d of methods for decoupling control and data channels and their associated signals and data payloads that includes Options 1 through 3 described above and elsewhere herein.

The foregoing description only describes a few of the many possible embodiments of the invention. Numerous changes and modifications to the embodiments disclosed herein may be made without departing from the spirit and scope of the invention. For example, while the examples herein utilize a macro-cell and small-cell, alternative embodiments may use different cells. Yet further, while only two cells are utilized in the examples described herein, it should be understood that more cells may be utilized in the inventive decoupling systems and methods. The metes and bounds of the scope of the present invention are best defined by the claims that follow.

What is claimed is:

1. A wireless system comprising:
a hardware controller operable to,
receive measurements of one or more parameters associated with a plurality of uplink data channels, a first number of the channels provided by a serving wireless cell operable to provide a downlink control channel to user equipment and a second number the channels provided by one or more non-serving wireless cells for the wireless user equipment; and
select the uplink data channel, from among the plurality of uplink data channels, that comprises the highest quality or that provides the highest throughput based on the received measurements and which is provided by one of the one or more non-serving wireless cells.

2. The system as in claim 1 wherein the controller is further operable to generate signals for transmission to the user equipment, the signals instructing the user equipment to use the selected uplink data channel to send data payloads to the non-serving wireless cell that is providing the selected uplink data channel.

3. The system as in claim 1 wherein the controller is a part of the serving wireless cell, another cell, or a part of a network management system.

4. The system as in claim 1 wherein the controller is part of a base station, and wherein the base station is further operable to exchange control signals with the user equipment via the downlink control channel.

5. The system as in claim 1 further comprising user equipment operable to receive control signals from the serving wireless cell, and transmit data payloads to one of the non-serving wireless cells.

6. The system as in claim 1 wherein the serving wireless cell comprises a macro-cell and the non-serving wireless cell providing the uplink data channel comprises a small-cell.

7. The system as in claim 1 wherein the serving wireless cell is operable to transmit downlink control signals at a power level that is higher than downlink control signals transmitted by the non-serving wireless cells.

8. The system as in claim 1 wherein the non-serving wireless cell that is providing the selected uplink data channel is operable to complete baseband processing.

9. The system as in claim 1 wherein the non-serving wireless cell that is providing the selected uplink data channel is operable to complete baseband processing and to co-ordinate scheduling with the serving wireless cell for the reception of data payloads from a plurality of user equipment, including the user equipment, to mitigate interference.

10. The system as in claim 1 wherein the non-serving wireless cell that is providing the selected uplink data channel is operable to receive and decode data payloads from other user equipment that has previously been associated with the non-serving wireless cell, cancel the signal contribution from the other equipment and attempt to decode the data payloads from the user equipment to mitigate interference.

11. The system as in claim 1 wherein the non-serving wireless cell that is providing the selected uplink data channel is operable to complete baseband processing, to co-ordinate scheduling with the serving wireless cell for the reception of data payloads from a plurality of user equipment, and perform power control.

12. A method for decoupling wireless control and data channels comprising:
receiving measurements, at a hardware controller, of one or more parameters associated with a plurality of uplink data channels, a first number of the channels provided by a serving wireless cell operable to provide a downlink control channel to user equipment and a second number of the channels provided by one or more non-serving wireless cells for the wireless user equipment; and
selecting the uplink data channel, from among the plurality of uplink data channels, by the hardware controller that comprises the highest quality or that provides the highest throughput based on the received measurements and which is provided by one of the one or more non-serving wireless cells.

13. The method as in claim 12 further comprising generating signals for transmission to the user equipment, the signals instructing the user equipment to use the selected uplink data channel to send data payloads to the non-serving wireless cell that is providing the selected uplink data channel.

14. The method as in claim 12 further comprising exchanging control signals with the user equipment via the downlink control channel.

15. The method as in claim 12 further comprising receiving control signals at user equipment from the serving wireless cell, and transmitting data payloads to one of the non-serving wireless cells from the user equipment.

16. The method as in claim 12 wherein the serving wireless cell comprises a macro-cell and the non-serving wireless cell providing the uplink data channel comprises a small-cell.

17. The method as in claim 12 further comprising completing baseband processing at the non-serving wireless cell that is providing the selected uplink data channel.

18. The method as in claim 12 further comprising completing baseband processing and coordinating scheduling at the non-serving wireless cell, that is providing the selected uplink data channel, with the serving wireless cell for the reception of data payloads from a plurality of user equipment, including the user equipment, to mitigate interference.

19. The method as in claim 12 further comprising receiving and decoding data payloads from other user equipment that has previously been associated with the non-serving wireless cell, cancelling the signal contribution from the other equipment and attempting to decode the data payloads from the user equipment to mitigate interference by the non-serving wireless cell that is providing the selected uplink data channel.

20. The method as in claim 12 further comprising completing baseband processing, coordinating scheduling with the serving wireless cell for the reception of data payloads from a plurality of user equipment, and performing power control by the non-serving wireless cell that is providing the selected uplink data channel.
